(19) United States
(12) Patent Application Publication
(10) Pub. No.: US 2007/0242832 A1
(43) Pub. Date: Oct. 18, 2007

(54) Acoustical Signal Processing Apparatus

(75) Inventors: Yoshiki Matsumoto, Osaka (JP); Kosuke Nishio, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/569,391

(22) PCT Filed: May 31, 2005
(86) PCT No.: PCT/JP05/09956

§ 371 Date: Nov. 20, 2006

(30) Foreign Application Priority Data
Jun. 4, 2004 (JP) 2004-166856

(51) Int. Cl. H04S 3/00

(52) U.S. Cl. 381/2

(57) ABSTRACT

An acoustic signal processing apparatus and an acoustic signal reproduction system capable of separately and simultaneously outputting more than six-channel audio signals including a sub-woofer without increasing the number of audio signal output terminals are provided. An acoustic signal processing apparatus includes a signal processing unit (decoding unit and downmixing unit) which decodes an audio input signal that is in a predetermined format and outputs eight-channel audio signals and downmixed two-channel audio signals, a first output unit which separately outputs the six-channel audio signals from among the eight-channel audio signals outputted by the decoding unit, and a second output unit which selects and outputs, based on an external setting, one of the two-channel audio signals other than the six-channel audio signals outputted by the first output unit and the two-channel downmixed audio signals outputted by the downmixing unit.

### TECHNICAL FIELD

The present invention relates to an acoustic signal processing apparatus and an acoustic signal reproduction system which decodes multi-channel audio signals.

### BACKGROUND ART

The 5.1 channel surround such as Dolby Digital (“Dolby” is a trademark of Dolby Laboratories) and DTS (“DTS” is a trademark of Digital Theater Systems) used for a DVD (Digital Versatile Disc) and the like, and MPEG-AAC (Moving Picture Experts Group-Advanced Audio Codec) used for digital television broadcasting and the like have been commonly used as a multi-channel audio format. As shown in FIG. 1, this 5.1 channel surround system is defined as a speaker arrangement in which five channels including two channels at front left and right (L, R), one channel at front center (C), two channels at surround left and right (SL, SR), and a subwoofer (SW) are arranged.

At present, audio formats which have more than 6 channels including a subwoofer, such as Dolby Digital EX (6.1 channel surround), DTS-ES (6.1 channel surround, “DTS-ES” is a trademark of Digital Theater Systems), and channel expansion processing such as Dolby Pro Logic IIx (7.1 channel surround) have been standardized. As shown in FIG. 2, the 6.1 channel surround system is a system in which one channel at the surround center (SC) is added to the speaker arrangement of the 5.1 channel surround system. As shown in FIG. 3, the 7.1 channel surround system is a system in which two channels at back left and right surround (BL, BR) are added to the speaker arrangement of the 5.1 channel surround system.

In the case where a multi-channel audio signal processing apparatus adapted to multi-channel audio signals with more than 6 channels is realized as an LSI, it is generally necessary to increase the number of output terminals along with the increase in the number of channels of the audio signals.

However, the increase in the number of output terminals causes an increase in LSI size, leading to an increase in LSI cost.

In order to solve this problem, the multi-channel audio signal processing apparatus described in Patent Reference 1 has been introduced as an apparatus which is applicable to an audio format having more than 6 channels including a subwoofer without increasing the number of output terminals.

This multi-channel audio signal processing apparatus outputs audio signals of less than six channels by decoding and downmixing audio signals of more than six channels. Therefore, it is applicable to the audio format for more than six channels including a subwoofer, without increasing the number of output terminals.

On the other hand, as shown in FIG. 4, there is an audio signal processing apparatus 401 for 5.1 channel surround which includes a downmixing unit 403 that downmixes audio signals of six channels into audio signals of DL and DR for outputting to headphones and a downmixed audio signal output terminal 405 which outputs the downmixed audio signals of DL and DR, in addition to a 5.1 channel decoding unit 402 which decodes an audio input signal into audio signals of six channels and an audio signal output terminal 404 which separately outputs the decoded audio signals of six channels.

Patent Reference 1: Japanese Laid-Open Patent Application No. 2001-352599

### DISCLOSURE OF INVENTION

### Problems that Invention is to Solve

However, in the audio signal processing apparatus shown in FIG. 4, the audio signals are generally not simultaneously reproduced with both headphones and speakers. Therefore, there is a problem that the downmixing terminals are not effectively utilized when the audio signals are outputted from the speakers.

In the multi-channel audio signal processing apparatus disclosed in Patent Reference 1, the audio signals are reproduced with speakers by reducing the number of output channels from eight or seven to six, so that the audio signals of more than six channels cannot be simultaneously outputted. Therefore, there is a problem that realism in the original 6.1 channel surround or 7.1 channel surround is lost.

The present invention is conceived in view of the aforementioned problems, and has an object to provide an acoustic signal processing apparatus and an acoustic signal reproduction system which is capable of separately and simultaneously outputting audio signals from more than six channels including a sub-woofer, without increasing the number of audio signal output terminals.

### MEANS TO SOLVE THE PROBLEMS

In order to achieve the aforementioned object, the acoustic signal processing apparatus according to the present invention is an acoustic signal processing apparatus which separately outputs N-channel audio signals, where N is a natural number N≧3, the apparatus including: a signal processing unit which decodes an audio input signal that is in a predetermined format, and outputs the N-channel audio signals and two-channel downmixed audio signals; a first output unit which separately outputs (N−2) channel audio signals from among the N-channel audio signals outputted by the signal processing unit; and a second output unit which selects and outputs, based on an external setting, one of: two-channel audio signals other than the (N−2) channel audio signals outputted by the first output unit from among the N-channel audio signals outputted by the signal processing unit; and the two-channel downmixed audio signals outputted by the signal processing unit.

This configuration allows exclusively switching between the function of the two output terminals as downmixed audio signals output terminal and the function of the two output terminals as audio signal output terminals for two channels out of N channels, and effectively utilizing the two output terminals. Therefore, an acoustic signal processing apparatus capable of separately and simultaneously outputting audio signals of more than six channels including a sub-woofer, without increasing the number of audio signal output terminals, can be provided.

Furthermore, in the acoustic signal processing apparatus according to the present invention, the signal processing unit includes: a first decoding unit which decodes the audio input signal that is in the predetermined format, and outputs the N-channel audio signals; and a downmixing unit which downmixes the N-channel audio signals outputted by the first decoding unit, and outputs the two-channel downmixed audio signals.

Furthermore, in the acoustic signal processing apparatus according to the present invention, the first decoding unit may output (N−K) channel silent signals when decoding the audio input signal into K-channel audio signals based on the number of channels included in the audio input signal in the predetermined format or the external setting, where K is a natural number K<N.

Furthermore, in the acoustic signal processing apparatus according to the present invention, the signal processing unit includes: a second decoding unit which decodes the audio input signal that is in the predetermined format, and outputs M-channel audio signals, where M is a natural number of N>M≧2; a second downmixing unit which downmixes the M-channel audio signals outputted by the second decoding unit, and outputs the two-channel downmixed audio signals; and a channel expansion unit which generates the N-channel audio signals by performing channel expansion processing on the M-channel audio signals outputted by the second decoding unit, and outputs the N-channel audio signals.

Furthermore, the acoustic signal processing apparatus according to the present invention, the channel expansion unit may output (N−L) channel silent signals when performing channel expansion processing on L-channel audio signals based on the number of channels included in the audio input signal in the predetermined format or the external setting, where L is a natural number N>L≧M.

In order to achieve the aforementioned object, the acoustic signal reproduction system according to the present invention is an acoustic signal processing method for separately outputting N-channel audio signals, where N is a natural number N≧3, the method including: a signal processing step of decoding an audio input signal that is in a predetermined format, and outputting the N-channel audio signals and two-channel downmixed audio signals; a first output step of separately outputting (N−2) audio signals from among the N-channel audio signals outputted in the signal processing step; and a second output step of selecting and outputting, based on an external setting, one of: two-channel audio signals other than the (N−2) channel audio signals outputted in the first output step from among the N-channel audio signals outputted in the signal processing step; and the two-channel downmixed audio signals outputted in the signal processing step.

This configuration allows exclusively switching between the function of the two output terminals as downmixed audio signal output terminals and the function of the two output terminals as audio signal output terminals for two channels out of N channels, and effectively utilizing the two output terminals. Therefore, an acoustic signal processing apparatus capable of separately and simultaneously outputting audio signals of more than six channels including a sub-woofer, without increasing the number of audio signal output terminals, can be provided.

In the acoustic signal reproduction system according to the present invention, the output switching unit may include a digital-to-analog converter having a mute function.

Furthermore, in the acoustic signal reproduction system according to the present invention, the output switching unit may include a power amplifier having a mute function.

Furthermore, the acoustic signal reproduction system according to the present invention further includes a headphone detecting unit which detects whether or not the headphones are connected, wherein the output switching unit outputs, to the second output unit, as the external setting, a control signal for controlling the second outputting unit to output the two-channel downmixed audio signals outputted by the signal processing unit in the case where the headphone detecting unit detects that the headphones are connected, and for controlling the second outputting unit to output the two-channel audio signals other than the audio signals of the (N−2) channels outputted by the first output unit from among the N-channel audio signals outputted by the signal processing unit in the case where the headphone detecting unit detects that the headphones are not connected.

Note that, the present invention is can be realized not only as such acoustic signal processing apparatus and an acoustic signal reproduction system, but also as an acoustic signal processing so method having the characteristic units of the acoustic signal processing apparatus as steps, as well as a program for causing a computer to execute those steps, and as an integrated circuit. Furthermore, it is obvious that such program can be distributed via a recording medium such as a CD-ROM or via a transmission medium such as the Internet.

### EFFECTS OF THE INVENTION

As is clear from the aforementioned description, according to the acoustic signal processing apparatus and acoustic signal reproduction system of the present invention, it is possible to provide an acoustic signal processing apparatus and an acoustic signal reproduction system which can separately and simultaneously output audio signals from more than six channels including a sub-woofer, without increasing the number of audio signal output terminals.

Therefore, the practical value of the present invention is very high in today's world where multi-channeled sources such as DVDs have proliferated.

### BRIEF DESCRIPTION OF DRAWINGS

FIG. 1 is a diagram showing a 5.1 channel multi-channel surround system.

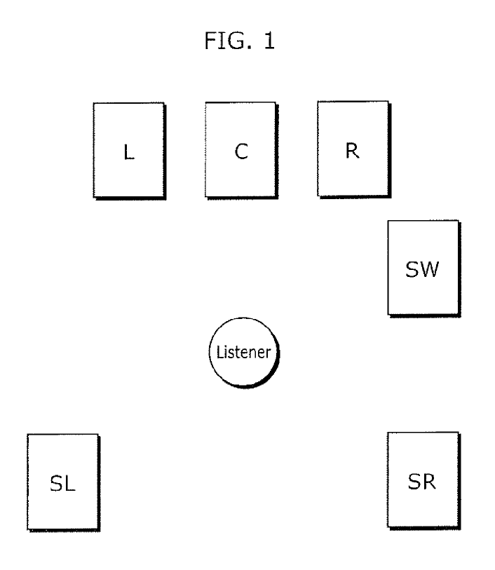

FIG. 2 is a diagram showing a 6.1 channel multi-channel surround system.

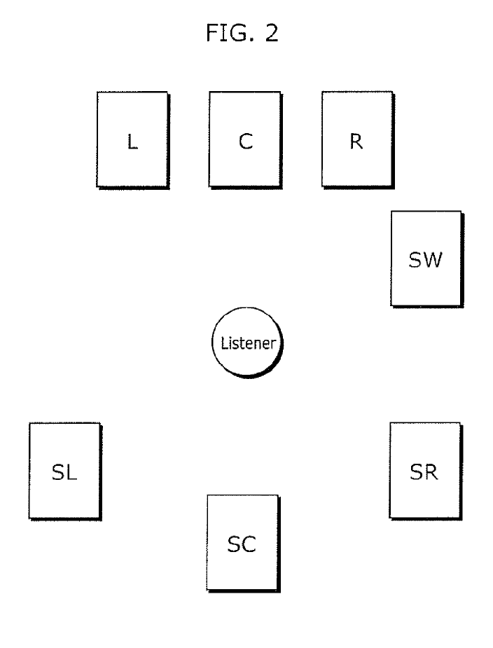

FIG. 3 is a diagram showing a 7.1 multi-channel surround system.

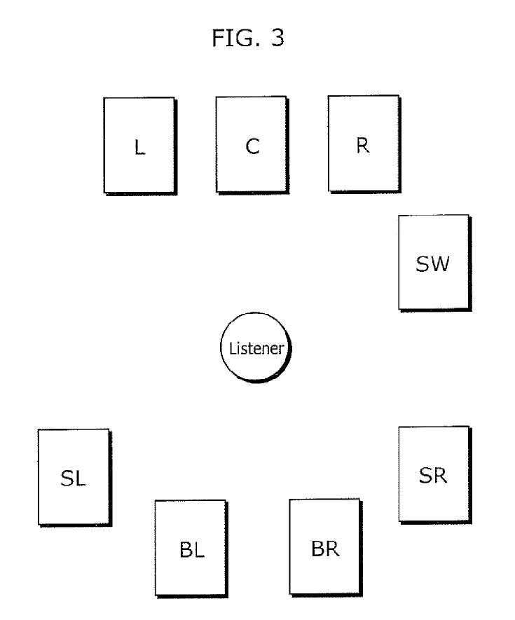

FIG. 4 is a diagram showing a configuration of a conventional audio signal processing apparatus for 5.1 channel surround.

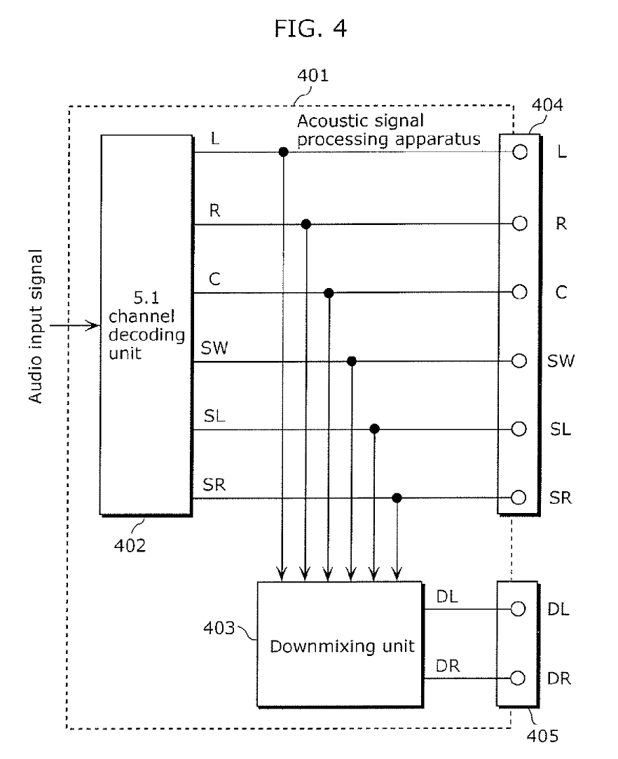

FIG. 5 is a diagram showing a configuration of an acoustic signal processing apparatus according to first and second embodiments of the present invention.

FIG. 6 is a diagram showing a configuration of an acoustic signal processing apparatus according to a third embodiment of the present invention.

FIG. 7 is a diagram showing a configuration of an acoustic signal processing apparatus according to fourth and fifth embodiments of the present invention.

FIG. 8 is a diagram showing an overall configuration of an acoustic signal reproduction system according to a sixth embodiment of the present invention.

FIG. 9 is a diagram showing an overall configuration of an acoustic signal reproduction system according to a seventh embodiment of the present invention.

FIG. 10 is a diagram showing an overall configuration of an acoustic signal reproduction system according to an eighth embodiment of the present invention.

FIG. 11 is a diagram showing an overall configuration of an acoustic signal reproduction system according to a ninth embodiment of the present invention.

### NUMERICAL REFERENCES

501, 601, 701, 801, 901,
1001, 1101 Acoustic signal processing apparatus
502, 602, 702 Decoding unit
503, 603, 703 Downmixing unit
504, 604, 704, 804, 904, 1004, 1104 First output unit
505, 605, 705, 805, 905, 1005, 1105 Second output unit
706 Channel expansion unit
800, 900, 1000, 1100 Acoustic signal reproduction system
807, 907, 1007 Output switching unit
811 to 818, 911 to 920, 1011 to 1018, 1111 to 1118 Digital-to-analog converter
821 to 830, 921 to 930, 1021 to 1030, 1121 to 1130 Power amplifier
831 to 838, 931 to 938, 1031 to 1038, 1131 to 1138 Speaker
841, 941, 1041, 1141 Headphones
1109 Headphone detecting unit

### BEST MODE FOR CARRYING OUT THE INVENTION

The embodiments of the present invention shall hereinafter be described in detail with reference to the attached drawings.

### First Embodiment

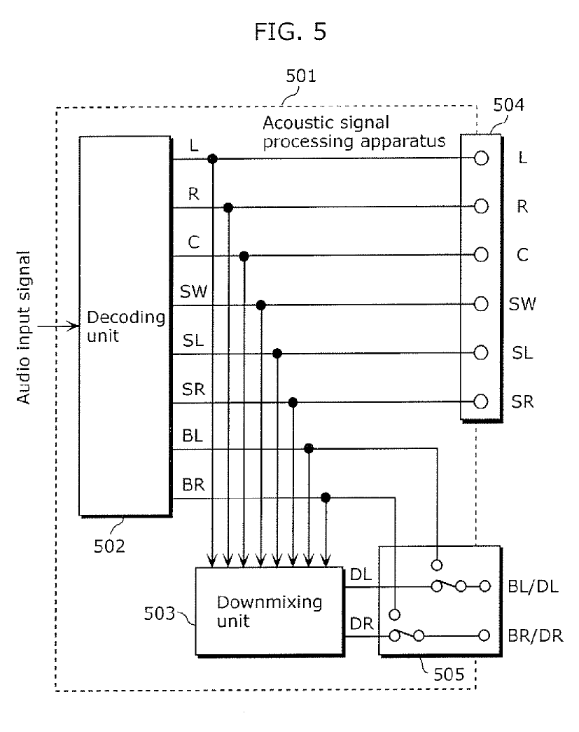

FIG. 5 is a diagram showing a configuration of an acoustic signal processing apparatus according to the first embodiment of the present invention. In FIG. 5, the example of the case where N=8 is shown.

As shown in FIG. 5, an acoustic signal processing apparatus 501 includes a decoding unit 502, a downmixing unit 503, a first output unit 504, and a second output unit 505. Note that, a signal processing unit is made up of the decoding unit 502 and the downmixing unit 503.

The decoding unit 502 decodes an audio input signal (for example, Dolby Pro Logic IIx Decoding), and outputs audio signals of eight-channels L, R, C, SW, SL, SR, BL, and BR.

The downmixing unit 503 downmixes audio signals L, R, C, SW, SL, SR, BL, and BR outputted by the decoding unit 502, and outputs two-channel audio signals DL and DR.

The first output unit 504 has six output terminals and six signal lines connected to the output terminals, and separately outputs audio signals L, R, C, SW, SL, and SR excluding audio signals BL and BR out of the audio signals L, R, C, SW, SL, SR, BL, and BR outputted by the decoding unit 502.

The second output unit 505 has two output terminals, two signal lines connected to the output terminals, and two switches. The audio signals BL and BR outputted by the decoding unit 502 and the audio signals DL and DR outputted by the downmixing unit 503 are inputted to the second output unit 505. The second output unit 505 selects and outputs, based on an external setting (instruction), the audio signals BL and BR or the audio signals DL and DR. In other words, the audio signals BL and BR and the audio signals DL and DR are exclusively outputted.

This configuration allows the two output terminals to be switched between functioning as downmixed audio signal output terminals and functioning as audio signal output terminals for two channels out of N channels, and effectively utilizing the two output terminals. Therefore, an acoustic signal processing apparatus capable of separately and simultaneously outputting audio signals of more than six channels including a sub-woofer, without increasing the number of audio signal output terminals, can be provided.

Note that, the first embodiment describes the case where the decoding unit 502 decodes an input signal into eight-channel signals, the decoding unit 502 may decode the input signal into seven-channel audio signals L, R, C, SW, SL, SR and SC, divide the audio signal SC into audio signals BL and BR, and output them.

Furthermore, whereas in the first embodiment, the audio signals BL and BR are inputted to the second output unit 505, the audio signals of any given two channels outputted by the decoding unit 502 may be inputted instead. In this case, the audio signals other than the audio signals inputted to the second output unit 505 may be outputted via the first output unit 504.

In addition, whereas the first embodiment describes the case of Dolby Pro Logic IIx Decoding, the present invention is also applicable to other decoding methods.

### Second Embodiment

It should be noted that the decoding unit 502 may be configured to output (N−K) channel silent signals in the case where an audio input signal is decoded into K-channel audio signals of K, where K is a natural number K<N, based on the number of channels included in the audio input signal or the external setting.

Here, the example of the case where N=8 is described with reference to FIG. 5.

In the case where the decoding unit 502 decodes the audio input signal into six-channel audio signals L, R, C, SW, SL and SR (for example, Dolby Digital Decoding), K=6 and N−K=2 are obtained. In this case, the decoding unit 502 outputs silent signals for BL and BR.

Accordingly, even in the case where the second output unit 505 is set to output the audio signals BL and BR when decoding the audio input signal into six-channel audio signals, it can be prevented that noise is outputted from the BL and BR.

Furthermore, in the case where the decoding unit 502 decodes the audio input signal into seven-channel audio signals L, R, C, SW, SL, SR, and SC (BL as an output terminal) (for example, Dolby Digital EX Decoding), K=7 and N−K=1 are obtained. In this case, the decoding unit 502 may output an SC channel audio signal from the BL output and a silent signal from the BR output.

### Third Embodiment

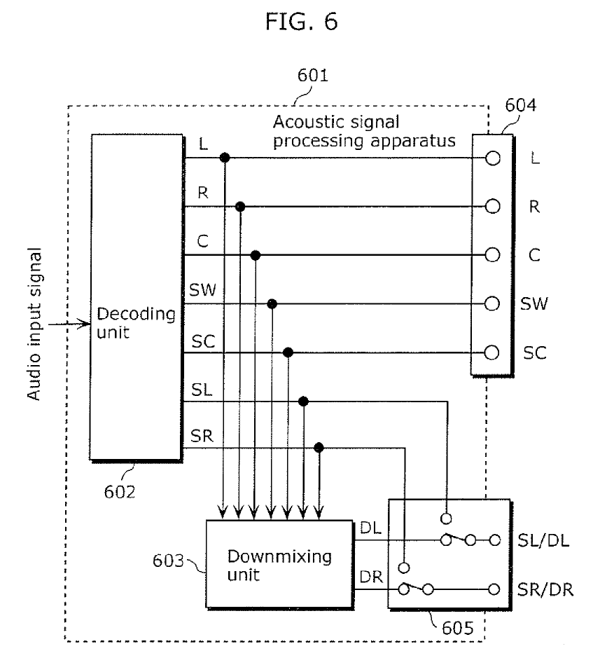

FIG. 6 is a diagram showing a configuration of an acoustic signal processing apparatus according to the third embodiment of the present invention. In FIG. 6, the example of the case where N=7 is described.

As shown in FIG. 6, an acoustic signal processing apparatus 601 includes a decoding unit 602, a downmixing unit 603, a first output unit 604, and a second output unit 605. Note that, the decoding unit 602, downmixing unit 603, first output unit 604, and second output unit 605 have the same functions as the decoding unit 502, downmixing unit 503, first output unit 504, and second output unit 505 of the acoustic signal processing apparatus 501, except the point that the number of channels of the audio signals to be processed and the types of the audio signals are different from those in the acoustic signal processing apparatus 501.

In other words, the decoding unit 602 decodes an audio input signal (for example, Dolby Digital EX Decoding), and outputs audio signals of seven channels L, R, C, SW, SL, SR and SC.

The downmixing unit 603 downmixes the audio signals L, R, C, SW, SL, SR, and SC outputted by the decoding unit 602, and outputs the two-channel audio signals DL and DR.

The first output unit 604 separately outputs the five-channel audio signals L, R, C, SW, and SC other than the audio signals SL and SR from among the seven-channel audio signals L, R, C, SW, SL, SR, and SC outputted by the decoding unit 602.

The audio signals SL and SR outputted by the decoding unit 602 and the audio signals DL and DR outputted by the downmixing unit 603 are inputted to the second output unit 605. The second output unit 605 selects and outputs the audio signals SL and SR or the audio signals DL and DR, based on an external setting (instruction).

This configuration allows the function of the two output terminals to be switched exclusively between functioning as downmixed audio signal output terminals and functioning as audio signal output terminals for two channels out of N channels, and effectively utilizing the two output terminals. Therefore, an acoustic signal processing apparatus capable of separately and simultaneously outputting audio signals of more than six channels including a sub-woofer, without increasing the number of audio signal output terminals, can be provided.

Furthermore, whereas, in the third embodiment, the audio signals SL and SR are inputted to the second output unit 605, the audio signals of any given two channels outputted by the decoding unit 602 may be inputted instead. In this case, the audio signals other than the audio signals inputted to the second output unit 605 may be outputted via the first output unit 604.

In addition, whereas the third embodiment describes the case of Dolby Digital EX Decoding, the present invention is applicable to other decoding methods.

Furthermore, whereas the first and third embodiments describe the case of N=8, 7, the present invention is also applicable to the case where N=6.

In addition, the decoding unit 602 may be configured to output (N−K) channel silent signals when decoding an audio input signal into K-channel audio signals (K is a natural number K<N), based on the number of channels included in the audio input signal or the external setting.

### Fourth Embodiment

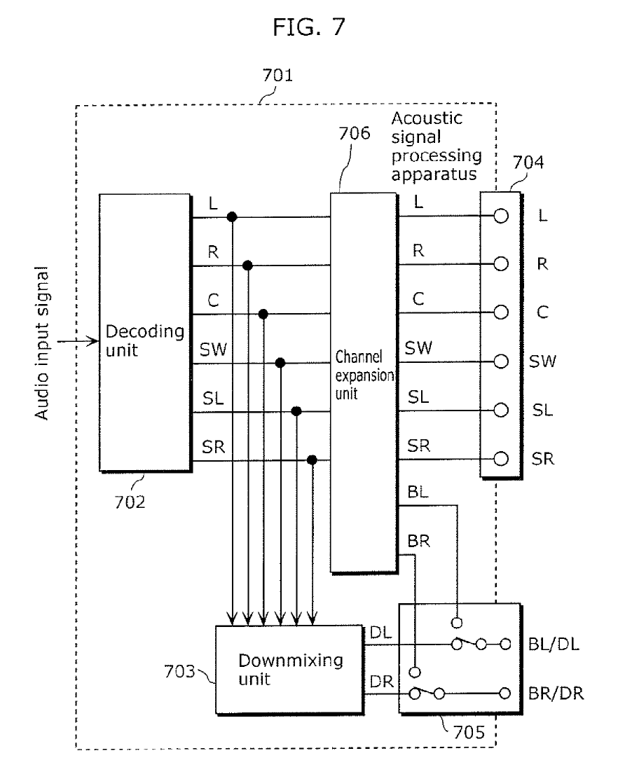

FIG. 7 is a diagram showing the configuration of the acoustic signal processing apparatus according to the fourth embodiment of the present invention. In FIG. 7, the example of the case where M=6, and N=8 is described.

As shown in FIG. 7, an acoustic signal processing apparatus 701 includes a decoding unit 702, a downmixing unit 703, a first output unit 704, a second output unit 705, and further a channel expansion unit 706. Note that, the decoding unit 702, downmixing unit 703, first output unit 704, and second output unit 705 have the same functions as the decoding units 502 and 602, downmixing units 503 and 603, first output units 504 and 604, and second output units 505 and 605 of the acoustic signal processing apparatuses 501 and 601, except the point that the number of channels of audio signals to be processed and the types of the audio signals are different from those in the acoustic signal processing apparatuses 501 and 605. Furthermore, in the present embodiment, a signal processing unit is made up of the decoding unit 702, the downmixing unit 703 and the channel expansion unit 706.

In other words, the decoding unit 702 decodes an audio input signal (for example, Dolby Digital Decoding), and outputs audio signals of six channels L, R, C, SW, SL, and SR.

The downmixing unit 703 downmixes the audio signals L, R, C, SW, SL, and SR outputted by the decoding unit 702, and outputs two-channel audio signals DL and DR.

The channel expansion unit 706 performs channel expansion processing (for example, Pro Logic IIx Decoding) on the six-channel audio signals L, R, C, SW, SL, and SR outputted by the decoding unit 702, and outputs the eight-channel audio signals L, R, C, SW, SL, SR, BL, and BR through this channel expansion processing.

The first output unit 704 separately outputs the audio signals L, R, C, SW, SL, and SR other than the audio signals BL and BR from among the audio signals L, R, C, SW, SL, SR, BL, and BR outputted by the channel expansion unit 706.

The audio signals BL and BR outputted by the channel expansion unit 706 and the audio signals DL and DR outputted by the downmixing unit 703 are respectively inputted to the second output unit 705, selects and outputs one of the audio signals BL and BR or the audio signals DL and DR based on the external setting (instruction).

This configuration allows the function of the two output terminals to be switched exclusively between functioning as downmixed audio signal output terminals and functioning as audio signal output terminals for two channels out of N channels, and effectively utilizing the two output terminals. Therefore, an acoustic signal processing apparatus capable of separately and simultaneously outputting audio signals of more than six channels including a sub-woofer, without increasing the number of audio signal output terminals, can be provided.

Furthermore, even in the situation under which most sources are 5.1 channels and few sources are multi-channels which have more than 5.1 channels, multi-channel audio signals can be outputted from the sources of 5.1 channels so that the practical value of the present invention can be improved.

Note that, in the fourth embodiment, the channel expansion unit 706 may expand audio signals into seven-channel audio signals L, R, C, SW, SL, SR, and SC (for example, Dolby Digital Ex Decoding), divide the SC into BL and BR, and output them.

Furthermore, whereas the fourth embodiment describes to input BL and BR into the second output unit, the audio signals of any given two channels outputted by the channel expansion unit 706 may be inputted.

### Fifth Embodiment

It should be noted that, in the acoustic signal processing unit 701, the channel expansion unit 706 may be configured to output (N−L) channel silent signals when expanding an audio input signal into L-channel audio signals (L is a natural number L≧M), based on the number of channels included in the audio input signal or the external setting.

Here, the example of the case where M=6 and N=8 is described.

In the case where the channel expansion unit 706 does not perform channel expansion processing, L=6 and N−L=2 are obtained.

In this case, the channel expansion unit 706 outputs the so input signals as they are with respect to the channels L, R, C, SW, SL, and SR, and outputs silent signals with respect to BL and BR. Accordingly, even in the case where the second output unit 705 is configured to output the audio signals BL and BR when channel expansion processing is not performed, it can be prevented that noise is outputted from BL and BR.

Furthermore, in the case where the channel expansion unit 706 performs expansion processing on the seven-channel audio signals L, R, C, SW, SL, SR, and SC (for example, Dolby Digital EX Decoding), L=7, and N−L=1 are obtained. In this case, an SC channel audio signal may be outputted from the BL output of the channel expansion unit 706, and a silent signal may be outputted from the BR output.

### Sixth Embodiment

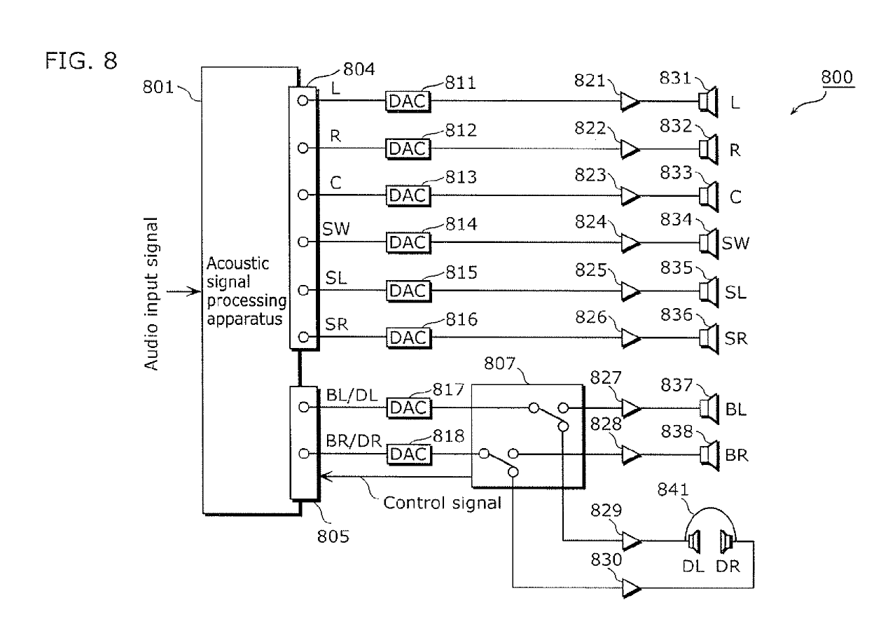

FIG. 8 is a diagram showing an overall configuration of an acoustic signal reproduction system according to the sixth embodiment of the present invention. In FIG. 8, the example of the case where N=8 is described.

As shown in FIG. 8, an acoustic signal reproduction system 800 includes an acoustic signal processing apparatus 801, DACs (Digital-to-Analog Converters) 811 to 818′ an output switching unit 807, power amplifiers 821 to 830, speakers 831 to 838, and headphones 841.

The audio signals L, R, C, SW, SL, and SR outputted by the first output unit 804 of the acoustic signal processing apparatus 801 are separately connected to the DACs 811 to 816 with respect to respective channels, converted into analog signals, amplified by the power amplifiers 821 to 826, and then reproduced through the speakers 831 to 836.

On the other hand, the audio signals BL and BR or DL and DR outputted by the output unit 805 of the acoustic signal processing apparatus 801 are converted into the analog signals by the DAC 817 and 818, and then selected so that the selected signals are outputted through speakers or headphones by the output switching unit 807 based on the external setting.

In the case where the output switching unit 807 is set to output through speakers, the output switching unit 807 outputs a control signal for selecting the audio signals BL and BR to the second output unit 805, and outputs the audio signals BL and BR to the power amplifiers 827 and 828. The audio signals BL and BR are amplified by the power amplifiers 827 and 828, and the amplified signals are reproduced by the speakers 837 and 838.

In the case where the output switching unit 807 is set to output through the headphones, the output switching unit 807 outputs a control signal for selecting the audio signals DL and DR to the second output unit 805, and outputs the audio signals DL and DR to the power amplifiers 829 and 830. The audio signals DL and DR are amplified by the power amplifiers 829 and 830, and the amplified signals are reproduced by the headphones 841. In this case, the speaker output may be muted by the DACs 811 to 816, the power amplifiers 821 to 826, or the like.

This configuration allows the function of the two output terminals to be switched exclusively between functioning as downmixed audio signal output terminals and functioning as audio signal output terminals for two channels out of N channels, and effectively utilizing the two output terminals. Therefore, an acoustic signal processing apparatus capable of separately and simultaneously outputting audio signals of more than six channels including a sub-woofer, without increasing the number of audio signal output terminals, can be provided.

### Seventh Embodiment

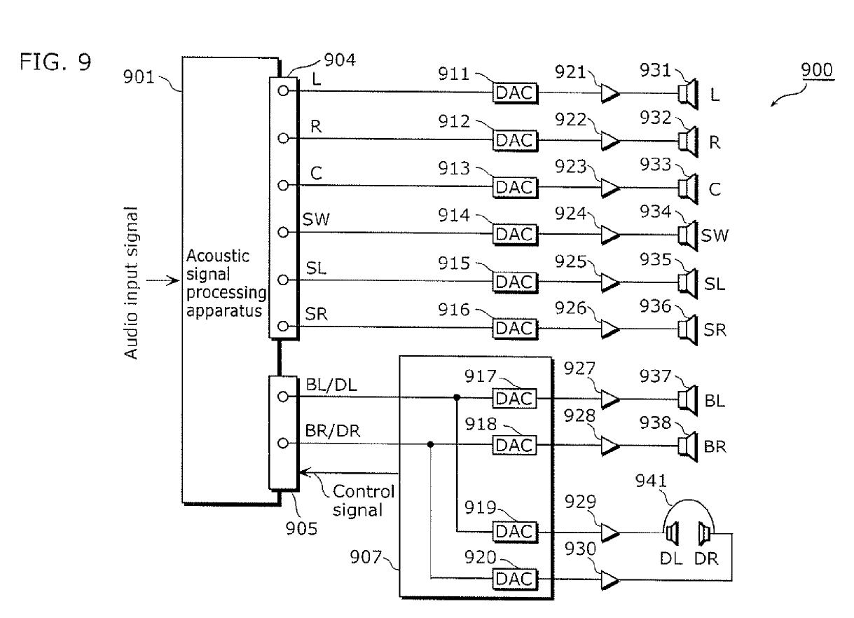

FIG. 9 is a diagram showing an overall configuration of an acoustic signal reproduction system according to the seventh embodiment of the present invention. In FIG. 9, the example of the case where N=8 is described.

As shown in FIG. 9, an acoustic signal reproduction system 900 includes an acoustic signal processing apparatus 901, DACs 911 to 920, power amplifiers 921 to 930, speakers 931 to 938, and headphones 941. Note that, an output switching unit 907 is made up of the DACs 917 to 920.

The audio signals L, R, C, SW, SL, and SR outputted by the first output unit 904 of the acoustic signal processing apparatus 901 are separately connected to the DACs 911 to 916 with respect to respective channels, converted into analog signals, amplified by the power amplifiers 921 to 926, and reproduced by the speakers 931 to 936.

On the other hand, the audio signals BL and BR or DL and DR outputted by the second output unit 905 are inputted to the four DACs 917 to 920.

In the case where the audio signals BL and BR are to be outputted by the speakers 937 and 938, the output switching unit 907 outputs a control signal for selecting the audio signals BL and BR to the second output unit 905, and the DAC 919 and 920 mute the headphone output.

Accordingly, the audio signals BL and BR amplified by the power amplifiers 927 and 928 are reproduced by the speakers 937 and 938, and silent signals are outputted by the headphones 941.

In the case where the audio signals DL and DR are outputted by the headphones 941, the output switching unit 907 outputs a control signal for selecting the audio signals DL and DR to the second output unit 905, and the DACs 917 and 918 mute the speaker output.

Accordingly, the audio signals DL and DR amplified by the power amplifiers 929 and 930 are reproduced by the headphones 941, and silent signals are outputted through the speakers 937 and 938.

In this case, the speaker output may be muted by the DACs 911 to 916 or the power amplifiers 921 to 926.

This configuration allows the function of the two output terminals to be switched exclusively between functioning as downmixed audio signal output terminals and functioning as audio signal output terminals for two channels out of N channels, and effectively utilizing the two output terminals. Therefore, an acoustic signal processing apparatus capable of separately and simultaneously outputting audio signals of more than six channels including a sub-woofer, without increasing the number of audio signal output terminals, can be provided.

### Eighth Embodiment

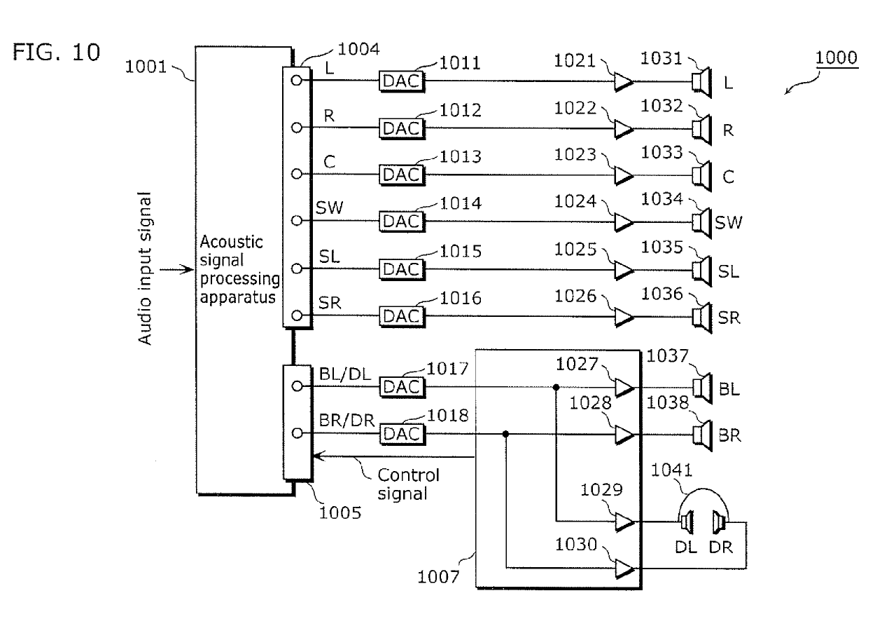

FIG. 10 is a diagram showing an overall configuration of an acoustic signal reproduction system according to the eighth embodiment of the present invention. In FIG. 10, the example of the case where N=8 is described.

As shown in FIG. 10, an acoustic signal reproduction is system 1000 includes an acoustic signal processing apparatus 1001, DACs 1011 to 1018, power amplifiers 1021 to 1030, speakers 1031 to 1038, and headphones 1041. An output switching unit 1007 is made up of the power amplifiers 1027 to 1030.

The audio signals (L, R, C, SW, SL, and SR) outputted by the first output unit 1004 are connected to the DACs 1011 to 1016 with respect to respective channels, converted into analog signals, amplified by the power amplifiers 1021 to 1026, and reproduced through the speakers 1031 to 1036.

On the other hand, the audio signals (BL and BR, or DL and DR) outputted by the second output unit 1005 are inputted to the two DACs 1017 and 1018, converted into analog signals, and inputted into the output switching unit 1007.

In the case where the audio signals BL and BR are outputted through the speakers 1037 and 1038, the output switching unit 1007 outputs a control signal for selecting the audio signals BL and BR to the second output unit 1005, and the power amplifiers 1029 and 1030 mute the headphone output. Accordingly, the audio signals BL and BR amplified by the power amplifiers 1027 and 1028 are reproduced through the speakers 1037 and 1038, and silent signals are outputted through the headphones 1041.

In the case where the audio signals DL and DR are outputted by the headphones 1041, the output switching unit 1007 outputs a control signal for selecting the audio signals DL and DR to the second output unit 1005, and the power amplifiers 1027 and 1028 mute the speaker output. Accordingly, the audio signals DL and DR amplified by the power amplifiers 1029 and 1030 are reproduced by the headphones 1041, and silent signals are outputted by the speakers 1037 and 1038. In this case, the speaker output may be muted by the DACs 1011 to 1016 or the power amplifiers 1021 to 1026.

This configuration allows the function of the two output terminals to be switched exclusively between functioning as downmixed audio signal output terminals and functioning as audio signal output terminals for two channels out of N channels, and effectively utilizing the two output terminals. Therefore, an acoustic signal processing apparatus capable of separately and simultaneously outputting audio signals of more than six channels including a sub-woofer, without increasing the number of audio signal output terminals, can be provided.

### Ninth Embodiment

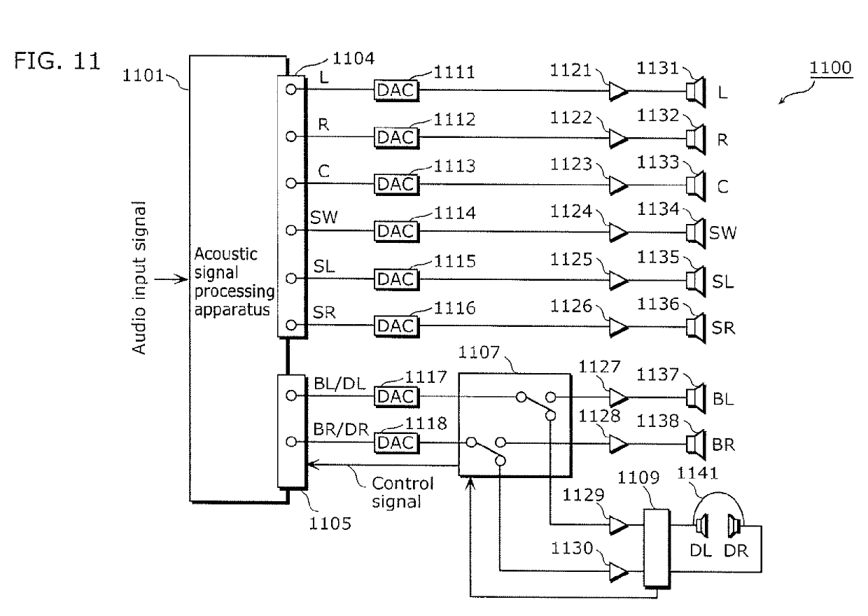

FIG. 11 is a diagram showing an overall configuration of an acoustic signal reproduction system according to the ninth embodiment of the present invention. In FIG. 11, the example of the case where N=8 is described.

As shown in FIG. 11, an acoustic signal reproduction system 1100 includes an acoustic signal processing apparatus 1101, DACs 1111 to 1118, power amplifiers 1121 to 1130, speakers 1131 to 1138, and headphones 1141, and further a headphone detecting unit 1109 and an output switching unit 1107.

In the case where the headphone detecting unit 1109 is set at a headphone socket and the headphones are not detected by the headphone detecting unit 1109, the output switching unit 1107 is set to output through the speakers. Here, the output switching unit 1107 outputs a control signal for selecting the audio signals BL and BR to the second output unit 1105. In the case where the headphones are detected by the headphone detecting unit 1109, the output switching unit 1107 is set to output through the headphones. Here, the output switching unit 1107 outputs a control signal for selecting the audio signals DL and DR to the second output unit 1105.

This configuration allows exclusively the function of the two output terminals to be switched exclusively between functioning as downmixed audio signal output terminals and functioning as audio signal output terminals for two channels out of N channels, and effectively utilizing the two output terminals. Therefore, an acoustic signal processing apparatus capable of separately and simultaneously outputting audio signals of more than six channels including a sub-woofer, without increasing the number of audio signal output terminals, can be provided.

### INDUSTRIAL APPLICABILITY

The present invention is useful as an acoustic signal processing apparatus which decodes multi-channel audio signals, and as an acoustic signal reproduction system using thereof, and is applicable to an audio-specific player, a player for audio and video, an AV amplifier, or the like.

1. An acoustic signal processing apparatus which separately outputs N-channel audio signals, where N is a natural number N≧3, said apparatus comprising:
a signal processing unit operable to decode an audio input signal that is in a predetermined format, and to output the N-channel audio signals and two-channel downmixed audio signals;
a first output unit operable to separately output (N−2) channel audio signals from among the N-channel audio signals outputted by said signal processing unit; and
a second output unit operable to select and output, based on an external setting, one of: two-channel audio signals other than the (N−2) channel audio signals outputted by said first output unit from among the N-channel audio signals outputted by said signal processing unit; and the two-channel downmixed audio signals outputted by said signal processing unit.

2. The acoustic signal processing apparatus according to claim 1,
wherein said signal processing unit includes:
a first decoding unit operable to decode the audio input signal that is in the predetermined format, and to output the N-channel audio signals; and
a downmixing unit operable to downmix the N-channel audio signals outputted by said first decoding unit, and to output the two-channel downmixed audio signals.

3. The acoustic signal processing apparatus according to claim 2,
wherein said first decoding unit is operable to output (N−K) channel silent signals when decoding the audio input signal into K-channel audio signals based on the number of channels included in the audio input signal in the predetermined format or the external setting, where K is a natural number K<N.

4. The acoustic signal processing apparatus according to claim
wherein said signal processing unit includes:
a second decoding unit operable to decode the audio input signal that is in the predetermined format, and to output M-channel audio signals, where M is a natural number of N>M≧2;
a second downmixing unit operable to downmix the M-channel audio signals outputted by said second decoding unit, and to output the two-channel downmixed audio signals; and
a channel expansion unit operable to generate the N-channel audio signals by performing channel expansion processing on the M-channel audio signals outputted by said second decoding unit, and to output the N-channel audio signals.

5. The acoustic signal processing apparatus according to claim 4,
wherein said channel expansion unit is operable to output (N−L) channel silent signals when performing channel expansion processing on L-channel audio signals based on the number of channels included in the audio input signal in the predetermined format or the external setting, where L is a natural number N>L≧M.

6. An acoustic signal processing method for separately outputting N-channel audio signals, where N is a natural number N≧3, said method comprising:
a signal processing step of decoding an audio input signal that is in a predetermined format, and outputting the N-channel audio signals and two-channel downmixed audio signals;
a first output step of separately outputting (N−2) audio signals from among the N-channel audio signals outputted in said signal processing step; and
a second output step of selecting and outputting, based on an external setting, one of: two-channel audio signals other than the (N−2) channel audio signals outputted in said first output step from among the N-channel audio signals outputted in said signal processing step; and ii) the two-channel downmixed audio signals outputted in said signal processing step.

7. An integrated circuit which functions as an acoustic signal processing apparatus which outputs N-channel audio signals, where N is a natural number N≧3, said integrated circuit comprising:
a signal processing unit operable to decode an audio input signal in a predetermined format, and to output the N-channel audio signals and two-channel downmixed audio signals;
a first output unit operable to separately output (N−2) channel audio signals from among the N-channel audio signals outputted by said signal processing unit; and
a second output unit operable to select and output, based on an external setting, one of: two-channel audio signals of other than the (N−2) channel audio signals outputted by said first output unit from among the N-channel audio signals outputted by said signal processing unit; and the two-channel downmixed audio signals outputted by said signal processing unit.

8. An acoustic signal reproduction system, using a signal processing apparatus to reproduce N-channel audio signals through speakers and reproduce a downmixed audio signal through headphones,
wherein said signal processing apparatus includes:
a signal processing unit operable to decode an audio input signal that is in a predetermined format, and to output the N-channel audio signals and two-channel downmixed audio signals;
a first output unit operable to separately output (N−2) channel audio signals from among the N-channel audio signals outputted by said signal processing unit; and
a second output unit operable to select and output, based on an external setting, one of: two-channel audio signals other than the (N−2) channel audio signals outputted by said first output unit from among the N-channel audio signals outputted by said signal processing unit; and the two-channel downmixed audio signals outputted by said signal processing unit,
wherein said acoustic signal reproduction system further comprises
an output switching unit operable to switch, between the speakers and the headphones for output, a connection mode of the selected audio signals outputted by said second output unit, and
wherein said output switching unit is operable to output, to said second output unit, a control signal for outputting the audio signals corresponding to the connection mode, as the external setting.

9. The acoustic signal reproduction system according to claim 8,
wherein said output switching unit includes a digital-to-analog converter having a mute function.

10. The acoustic signal reproduction system according to claim 8,
wherein said output switching unit includes a power amplifier having a mute function.

11. The acoustic signal reproduction system according to claim 8, further comprising
a headphone detecting unit operable to detect whether or not the headphones are connected,
wherein said output switching unit is operable to output, to said second output unit, as the external setting, a control signal for controlling said second outputting unit to output the two-channel downmixed audio signals outputted by said signal processing unit in the case where said headphone detecting unit detects that the headphones are connected, and for controlling said second outputting unit to output the two-channel audio signals other than the audio signals of the (N−2) channels outputted by said first output unit from among the N-channel audio signals outputted by said signal processing unit in the case where said headphone detecting unit detects that the headphones are not connected.
